(19) United States
(12) Patent Application Publication
(10) Pub. No.: US 2025/0228407 A1
(43) Pub. Date: Jul. 17, 2025

(54) FOOD RACK FOR A GRILL OR SMOKER

(71) Applicant: Joe Miller, Hendersonville, TN (US)

(72) Inventor: Joe Miller, Hendersonville, TN (US)

(21) Appl. No.: 18/410,233

(22) Filed: Jan. 11, 2024

(51) Int. Cl. A47J 43/18; A47J 37/07

(52) U.S. Cl. CPC A47J 43/18; A47J 37/0786

(57) ABSTRACT

A food rack includes a frame configured to contact a cooking surface of a cooker and a handle connected to the frame. The food rack also includes a plurality of holding members. Each holding member extends upwardly from the frame, away from the cooking surface, and comprises a main body and a first prong extending upwardly from the main body. The first prong is configured to pierce and hold food thereon.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This disclosure relates generally to accessories for cooking food in barbeque (BBQ) grills. More particularly, this disclosure pertains to assemblies of food racks and methos of use thereof.

Food racks are used to hold the food in a particular orientation while the food is being cooked on a grill, such as a gas BBQ grill. Food racks also help to space the food items at set distances so that the food cooks evenly. Furthermore, food racks allow a user to easily transport multiple food items to and from the grill.

One kind of food rack is a wing rack which is used for cooking chicken wings. A typical wing rack includes an elevated holding rack that is supported by four or more support posts which contact the cooking surface of the grill. The holding rack is generally composed of a bent wire frame that forms a zig-zag pattern, defining spaces therebetween to receive the wings or drumsticks. In use, the food is suspended and retained in place by the holding rack. Conventional wing racks are cumbersome to use and prone to collapsing during use or transportation thereof. For instance, it is common for a support post to get caught between the grates of a grill, causing the wing rack to collapse or the wings to fall out of the holding rack. Additionally, conventional wing racks provide an insufficient amount of space in between juxtaposed wings such that the wings usually touch one another and unevenly cook. Therefore, improvements in wing racks are needed.

### BRIEF SUMMARY OF THE INVENTION

This Brief Summary is provided to introduce a selection of concepts in a simplified form that are further described below in the Detailed Description. This Brief Summary is not intended to identify key features or essential features of the claimed subject matter, nor is it intended to be used as an aid in determining the scope of the claimed subject matter. Features of the presently disclosed invention overcome or minimize some or all of the identified deficiencies of the prior art, as will become evident to those of ordinary skill in the art after a study of the information presented in this document.

Aspects of the invention provide a food rack and methods of use thereof for transporting and holding food while the food is being cooked on a cooking surface of a cooker. The food rack elevates the food and evenly spaces the food so that the food is evenly cooked. The food rack is also easy to transport to and from the cooker.

In one aspect, a food rack includes a frame configured to contact a cooking surface of a cooker, a handle connected to the frame, and a plurality of holding members. Each holding member extends upwardly from the frame, away from the cooking surface, and comprises a main body and a first prong extending upwardly from the main body and configured to pierce and hold food thereon.

In one aspect, a food rack includes a frame configured to contact a cooking surface of a cooker. The frame comprises first, second, and third beams parallel to one another and interconnected by cross beams. The first beam is disposed in between the second beam and the third beam. The food rack also includes a handle connected to the first beam and extending upwardly therefrom. The food rack also includes a plurality of holding members comprising first, second, and third sets of holding members respectively connected to and evenly spaced along the first, second, and third beams. Each holding member extends upwardly from the frame, away from the cooking surface, and comprises a main body and a first prong extending upwardly from the main body. The first prong is configured to pierce and hold food thereon.

In one aspect, a food rack includes a frame configured to contact a cooking surface of a cooker. The frame comprises a first elongated beam extending along a longitudinal axis, a second beam perpendicular to the longitudinal axis and connected to one end of the first elongated beam, and a third beam perpendicular to the longitudinal axis and connected to an opposite end of the first elongated beam. The food rack also includes a handle connected to the first beam and extending upwardly therefrom. The food rack also includes a plurality of holding members comprising first, second, and third sets of holding members respectively connected to and evenly spaced along the first, second, and third beams. Each holding member extends upwardly from the frame, away from the cooking surface, and comprises a main body and a first prong extending upwardly from the main body. The first prong is configured to pierce and hold food thereon.

### BRIEF DESCRIPTION OF THE SEVERAL VIEWS OF THE DRAWINGS

FIG. 1 is a top perspective view of an exemplary embodiment of a food rack for holding food atop a cooking surface of a grill.

FIG. 2 is a front plan view of the food rack of FIG. 1.

FIG. 3 is a right side plan view of the food rack of FIG. 1.

FIG. 4 is a front plan view of a holder of the food rack in isolation.

FIG. 5 is a top perspective view of an exemplary embodiment of another food rack.

FIG. 6 is a front plan view of the food rack of FIG. 5.

FIG. 7 is a right side plan view of the food rack of FIG. 5.

FIG. 8 is an isometric view of the food rack of FIG. 1 loaded with chicken pieces.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. As used herein, the upright position of the food rack is when loaded with food and placed on a generally horizontal surface such as a smoker or grill grate. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

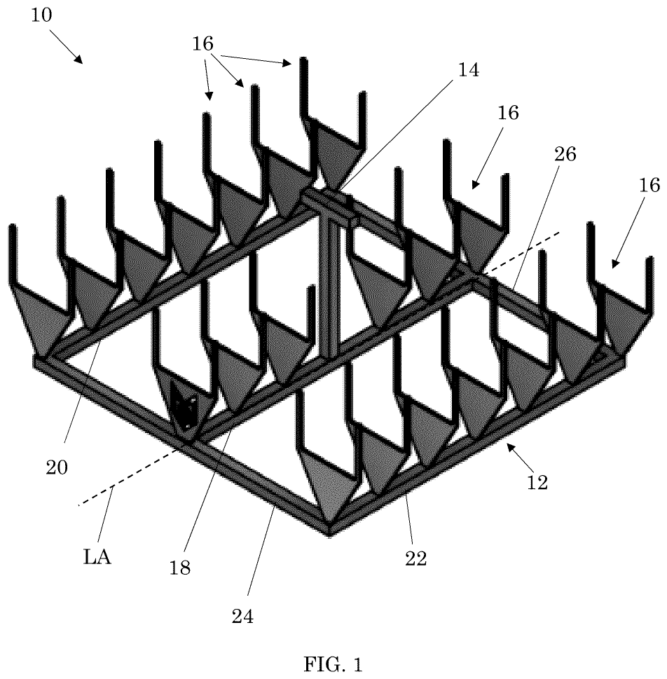

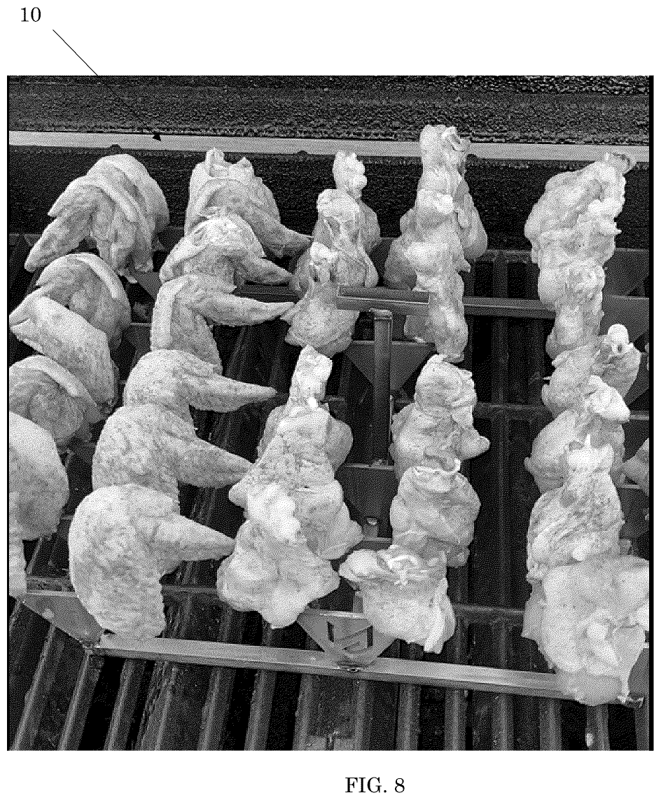

FIGS. 1-4 and 8 illustrate an embodiment of a food rack 10 for holding food thereon while the food is cooked in a cooker, such as a smoker, gas grill, or charcoal grill. The food rack 10 may be in the form of a wing rack for specifically holding chicken wings and drumsticks or other food items. The food rack 10 generally includes a frame 12 configured to contact a cooker's cooking surface CS, as shown in phantom in FIG. 1, a handle 14 connected to the frame 12, and multiple holding members 16 connected to and extending upwardly from the frame 12.

When cooking multiple, individual food items various issues arise. One issue is even cooking. Due to the number and location of the food items on the cooking surface CS of the grill, it can be challenging to properly cook each food item without under or over cooking some of the food items. Another issue is ease of use of a given food rack. In general, food racks save time in cooking and transportation. However, conventional food racks are not sturdy and are prone to failure or snagging on the grates of a grill. Additionally, conventional food racks loosely hold and suspend the food items, which may cause the food items to fall off of the food rack 10. In contrast to conventional food racks, the food rack 10, as discussed in more detail below, is easy to use, saves time, and allows the food to be evenly cooked.

The frame 12 is configured to contact the cooking surface CS of the cooker and transfer heat from the cooking surface CS to the holding members 16. The frame 12 defines a flat bottom surface that rests directly on the cooker. Unlike legs on a frame of a conventional food rack, the frame 12 does not get caught or snagged on the grates of a grill. The frame 12 can comprise any desired material, such as metal.

The frame 12 includes multiple beams 18, 20, 22, 24, 26 interconnected to one another. For instance, the frame 12 may include first, second, and third beams 18, 20, 22 that are parallel to one another and interconnected by cross beams 24, 26. In other words, the frame 12 may include a middle beam 18 extending along a longitudinal axis LA and disposed in between left and right beams 20, 22, which are joined by two or more cross beams 24, 26 that are perpendicular thereto. The cross beams 24, 26 are connected to the longitudinal ends of the beams 18, 20, 22. Together, the beams 18, 20, 22, 24, 26 define a stable platform which sits flush against the cooking surface CS. The cross beams 24, 26 may be differently configured. For instance, the cross beams 24, 26 may be connected to a middle portion of the other beams 18, 20, 22 instead of their ends or the cross beams 24, 26 may form X-braces between the other beams 18, 20, 22. The beams 18, 20, 22, 24, 26 may all reside in a common plane. Any of the beams 18, 20, 22, 24, 26 may mount and support holding members 16 thereon. The frame 12 may be monolithically formed or composed of individual beams that are fastened together by fasteners or welded to one another. The frame 12 may or may not include additional support members, such as feet.

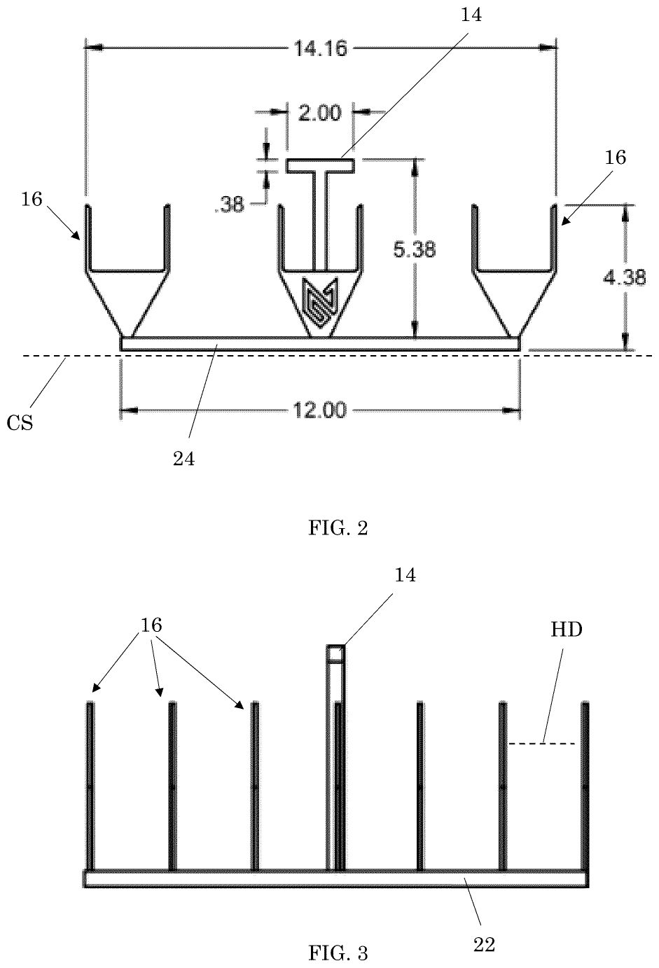

The handle 14 is connected to and extends upwardly from the frame 12. More particularly, the handle 14 is connected to the middle beam 18. The handle 14 includes a stem, e.g., an elongated vertical beam, and a cross beam extending on either side of the stem. The handle 14 extends further above the top surfaces of the holding members (FIG. 2). Thereby, the user may easily grab the handle 14 to transport the food rack 10 without contacting the food retained on the holding members 16. The handle 14 is also sturdy and centrally located so that the weight of the food rack 10 is evenly balanced, augmenting usability and ease of transportation to and from the grill. The handle 14 may comprise any desired material, such as metal. The handle 14 may or may not be composed of the same material as the beams.

As discussed in more detail below, the food rack 10 may have any desired configuration of holding members 16 disposed on the frame 12. The holding members 16 may be grouped in sets and evenly disposed along the length of a corresponding beam at set distances HD (FIG. 3). In the present configuration, six holding members 16 are located on the middle beam 18, and seven holding members 16 are disposed on each of the left and right beams 20, 22. Thereby, with 20 total holding members 16, the food rack 10 may hold 40 wings and/or drumsticks. To accommodate the handle 14, the set of holding members 16 associated with the middle beam 18 that mounts the handle 14 is lesser in number than the other set(s) of holding members 16. Thereby, the sets of holding members 16 are equally spaced apart from one another for evenly cooking the food (FIG. 3).

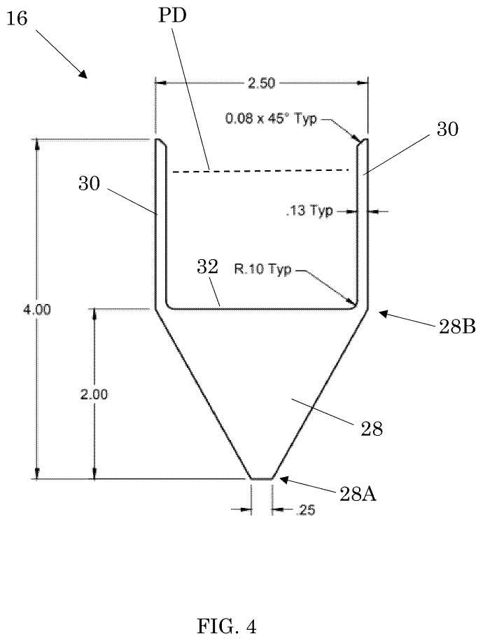

Referring now specifically to FIG. 4, each holding member 16 includes a main body 28 and one or more prongs 30 extending upwardly from the main body 28 that are configured to pierce and hold food thereon. As shown, each holding member 16 includes two prongs 30 located at each side of the main body 28. The prongs 30 are spaced apart from one another at a distance PD such that the food retained by the prongs 30 are separated from one another at a distance for evenly cooking the food. Each holding member 16 may comprise any desired material, such as metal. For example, each holding member 16 can be comprised of 3/16 inch thick 308 stainless steel. Each holding member 16 can be rigidly connected to the frame 12 such as fastened with one or more fasteners or welded onto the frame 12.

During cooking of the food, the frame 12 transfers heat to the holding members 16. In turn, the body of each holding member 16 evenly transfers heat to both of its prongs 30. Thereby, since the prongs 30 extend into the food, the heat radiating off of the prongs 30 assists in internally cooking the food from within.

The main body 28 of each holding member 16 extends from a proximal end 28A, which is connected to the frame 12, to a distal end 28B. The main body 28 extends outwardly as the main body 28 extends away from the frame 12 such that the distal end 28B is wider than the proximal end 28A. The main body 28 may have a substantially triangular configuration. The distal end 28A of the main body 28 defines a shelf 32 upon which the food may contact and rest upon. Hence, the shelf 32 supports the weight of the food after it has been placed on the prongs 30 so that the food is suspended above the frame 12. The shelf 32 prevents the food from burning or over cooking because the shelf 32 prevents the food from sliding further down the holding member 16, closer to the cooking surface CS of the cooker. In other words, the prong(s) 30 and the shelf 32 adjacent thereto secure the food and immobilize the food from moving horizontally and vertically, respectively. The shelf 32 is substantially horizontal and perpendicular to each prong 30. The shelf 32 defines a flat surface that is substantially perpendicular to the prongs 30 and parallel to the cooking surface.

Each prong 30 is configured to pierce and hold the food. The distance PD in between the prongs 30 is defined by the length of the shelf 32. The prongs 30 may have the same height. Alternatively, the prongs 30 may differ in height. The prongs 30 can define an open space therebetween. The open space may have a substantially rectangular cross section. Each prong 30 may have a chamfered end defining a pointed tip for easily piercing the food.

Each holding member 16 may be a single uniform component. Therein, the prongs 30 can be monolithically formed with the main body 28. Additionally, each prong 30 and the main body 28 can comprise equal thicknesses such that heated air from the cooker is unobstructed by the main body 28 for evenly cooking the food. In other words, the entire main body 28 and the prongs 30 of each holding member 16 have the same thicknesses. The matching thicknesses allow for a greater amount of airflow to travel from the distal end 28A of the main body 28 to each prong 30. Additionally, the reduced profile of the main body 28 and prongs 30 of each holding member 16 allow for a significant amount of airflow to pass in between juxtaposed holding members 16. This augmented airflow assists in evenly cooking the food. For instance, the end pieces located at the ends of the frame 12 cook evenly with the middle pieces. It is contemplated however that each holding member 16 may not have a uniform thickness. The shelf 32 may or may not have a differing thickness than the rest of the main body 28 or the prongs 30. Additionally, the prongs 30 may have a lessor or greater thickness than the main body 28.

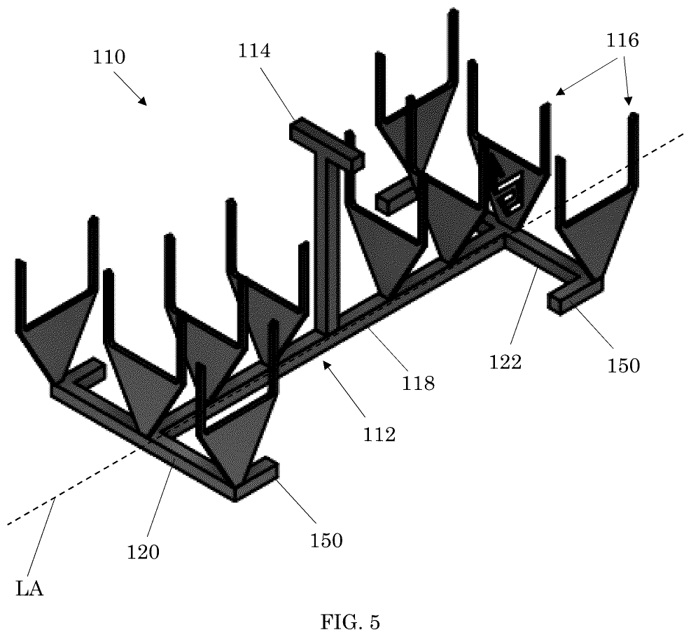

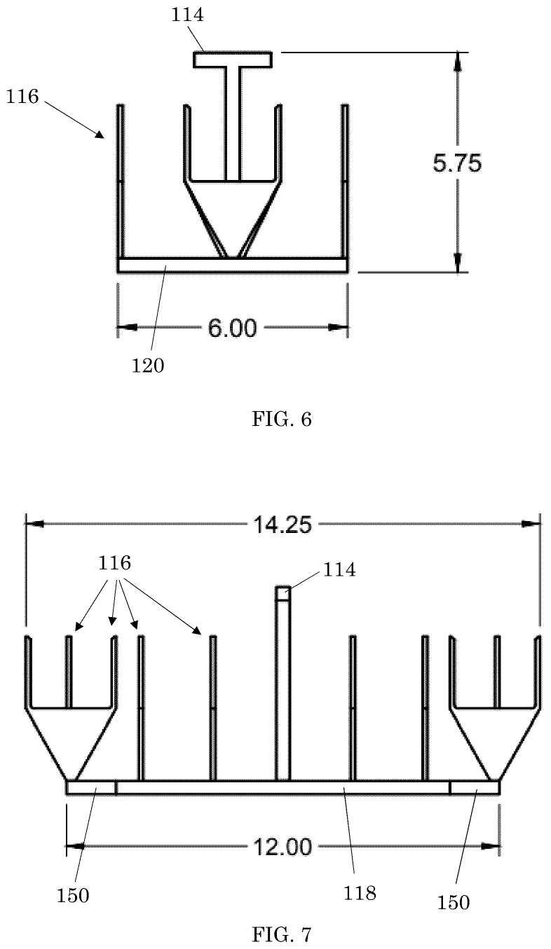

Referring now to FIGS. 5-7, there is shown another embodiment of a food rack 110. The food rack 110 may be substantially similar to the food rack 10 as discussed above, except that the food rack 110 has a differing frame 112 and configuration of holding members 116. Like reference characters have been used to identify like components except for the 100 series designation.

The frame 112 includes a single elongated beam 118 and two shortened beams 120, 122 connected to the ends of the elongated beam 118. The elongated beam 118 mounts the handle 114 thereon. The elongated beam 118 extends along a longitudinal axis LA, and the elongated beam 118 is longer than the shortened beams 120, 122. The shortened beams 120, 122 are perpendicular to the longitudinal axis LA of the elongated beam 120. The frame 112 may additionally include lateral support beams 150 connected to and extending inwardly from the shortened beams 120, 122 such that the lateral support beams 150 extend toward each other.

The holding members 116 can be disposed on the frame in any desired configuration. In the present configuration, two holding members 116 are located on the shortened beams 120, 122 and six holding members 116 are located on the elongated beam 118. The sets of holding members 116 on the shortened beams 120, 122 are equal in number. The set of holding members 116 on the elongated beam 118 is greater in number than other sets of holding members 116. To evenly space apart and cook the food, the sets of holding members 116 on the shortened beams 120, 122 are perpendicularly offset from the first set of holding members 116 on the elongated beam 118.

In one embodiment, the food rack 10 is fabricated from square tube steel and plate steel. The holding members 16 are stamped or cut from plate steel. The beams are cut from square tube. The handle 14 is T shaped and formed of square tube steel. The parts of the food rack 10 are welded to one another to form the food rack 10. The food rack 10 may be formed of mild steel, aluminum, or stainless steel. In one embodiment, the food rack 10 includes a plurality of handles 14. In one embodiment, the distance between each holding member is the same as the distance between each prong on a single holding member such that the prongs form a grid and are evenly spaced from one another to promote even cooking of each piece of food on each prong.

It is contemplated within the scope of the claims that the holding members may not be identical components. It is contemplated within the scope of the claims that although a plurality of holding members may be substantially identical, a food rack may include holding members within the plurality that differ in shape, size, and number of prongs.

It is noted that the frame and holding members may be arranged in various configurations. For example, the frame may include only one or two or more beams and the holding members may include only one set or two or more sets arranged on the corresponding beam(s). Additionally, for example, the frame can include parallel first and second beams and the holding members can be arranged in first and second sets that are evenly spaced along the lengths of the first and second beams, respectively. Furthermore, for example, the frame can include three parallel beams and the holding members can be arranged in three sets that are evenly spaced along the lengths of the first, second, and third beams. The various sets of holding members may be parallel to one another. The various sets of holding members may or may not differ in number from one another. The set of holding members associated with the beam that mounts the handle may have one less holding member than the other set(s) of holding members. Still further, for example, the frame may include a single elongated beam and one or more shortened perpendicular beams which respectively mount sets of holding members. The additional set(s) of holding members mounted on the shortened beam(s) may be lesser in number than the first set of holding members mounted on the elongated beam. In such a configuration, the sets of holding members may be perpendicular to one another.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful FOOD RACK FOR A GRILL it is not intended that such references be construed as limitations upon the scope of this invention except as set forth in the following claims.

What is claimed is:

1. A food rack, comprising:
a frame configured to be supported by a cooking surface of a cooker;
a handle connected to the frame; and
a plurality of holding members, each holding member extending upwardly from the frame and away from the cooking surface when the food rack is an upright position on the cooking surface such that the frame extends generally horizontally, wherein each holding member comprises a main body and a first prong extending upwardly from the main body, said first prong configured to pierce and retain food thereon.

2. The food rack of claim 1, wherein:
each holding member of the plurality of holding members further comprises a second prong extending upwardly from the main body and configured to pierce and retain food thereon; and
the second prong is spaced apart from the first prong by a predetermined distance such that the food retained by the first prong and food retained by the second prong is separated for evenly cooking the food retained on the first prong and the food retained on the second prong.

3. The food rack of claim 1, wherein:
each holding member of the plurality of holding members further comprises a shelf adjacent to the first prong;
when the first prong pierces the food and retains the food thereon, the first prong limits horizontal movement of the food retained thereon; and
when the first prong pierces the food and retains the food thereon, the shelf limits vertical movement of the food retained on the first prong.

4. The food rack of claim 1, wherein:
the main body of each holding member of the plurality of holding members extends has a proximal end connected to the frame and a distal end opposite the proximal end;
the main body extends outwardly as the main body extends away from the frame such that the distal end is wider than the proximal end;
each holding member of the plurality of holding members further comprises a second prong;
the first prong is connected to the distal end of the main body at a first side of the main body; and
the second prong is connected to the distal end of the main body at a second side of the main body opposite the first side of the main body such that the second prong is spaced apart from the first prong by a predetermined distance and the food retained by the first prong and food retained by the second prong is separated for evenly cooking the food retained on the first prong and the food retained on the second prong.

5. The food rack of claim 1, wherein:
the main body of each holding member of the plurality of holding members extends has a proximal end connected to the frame and a distal end opposite the proximal end;
the first prong is connected to the distal end of the main body;
the main body defines a shelf at the distal end of the main body that extends perpendicularly from the first prong;
when the first prong pierces the food and retains the food thereon, the shelf contacts the food and supports the food so that the food is suspended above the frame; and
the shelf of each main body of each holding member of the plurality of holding members is at the same height above the frame when the food rack is in the upright position with the frame extending generally horizontally.

6. The food rack of claim 1, wherein:
the frame comprises:
a first beam; and
a second beam extending parallel to the first beam;
the handle is connected to and extends upwardly from the first beam when the food rack is in the upright position with the frame extending generally horizontally; and
the plurality of holding members comprises:
a first set of holding members connected to and evenly spaced along the first beam; and
a second set of holding members connected to and evenly spaced along the second beam, the second set of holding members being greater in number than the first set of holding members.

7. The food rack of claim 1, wherein:
the frame comprises:
a first beam; and
a second beam extending parallel to the first beam;
the handle is connected to and extends upwardly from the first beam;
the handle is T shaped;
the plurality of holding members comprises:
a first set of holding members connected to and evenly spaced along the first beam; and
a second set of holding members connected to and evenly spaced along the second beam, wherein the second set of holding members are positioned along the second beam even with the first set of holding members on the first beam; and
a spacing between the holding members in each set of holding members is the same as a predetermined distance between the first prong and a second prong of the holding member of the first prong such that food retained on each prong of the food rack is spaced equidistant.

8. The food rack of claim 1, wherein:
the frame comprises:
a first beam; and
a second beam extending perpendicular to the first beam;
the handle is connected to and extends upwardly from the first beam when the food rack is in the upright position; and
the plurality of holding members comprises:
a first set of holding members connected to and evenly spaced along the first beam from the handle; and
a second set of holding members connected to the second beam and perpendicularly offset from the first set of holding members, the second set of holding members being lesser in number than the first set of holding members.

9. The food rack of claim 1, wherein:
each holding member of the plurality of holding members further comprises a second prong; and
the first prong, second prong, and main body of each holding member of the plurality of holding members are integrally formed from metal plate.

10. The food rack of claim 1, wherein the handle extends above the first prong of each holding member of the plurality of holding members so that a user can lift the food rack via the handle without contacting food retained on the first prongs of the plurality of holding members.

11. The food rack of claim 1, wherein:
the food rack is configured as a wing rack; and
the food is a plurality of wings or drumsticks of an animal.

12. A food rack, comprising:
a frame configured to contact a cooking surface of a cooker, the frame comprising first, second, and third beams parallel to one another and interconnected by at least one cross beam, the first beam disposed in between the second beam and the third beam;
a handle connected to the first beam and extending upwardly therefrom when the food rack is in an upright position; and
a plurality of holding members comprising first, second, and third sets of holding members respectively connected to and evenly spaced along the first, second, and third beams,
wherein:
each holding member of the plurality of holding members extends upwardly from the frame, away from a cooking surface when the food rack is supported by the cooking surface,
each holding member of the plurality of holding members comprises a main body and a first prong extending upwardly from the main body, and
the first prong is configured to pierce and retain food thereon.

13. The food rack of claim 12, wherein:
the holding members of the first, second, and third sets of holding members are spaced evenly their respective beams, and
the second set of holding members are positioned along the second beam and the third set of holding members are positioned along the third beam even with the first set of holding members on the first beam.

14. The food rack of claim 12, wherein the first set of holding members is lesser in number than each of the second and third sets of holding members such that the handle is centered on the first beam and the holding members of the first set of holding members are spaced from the handle.

15. The food rack of claim 12, wherein:
each of the first, second, and third beams each have a longitudinal end; and
the at least one cross beam is perpendicular to and connected to the longitudinal end of the first, second, and third beams, defining a generally planar frame which sits flush against the cooking surface when the food rack is on the cooking surface in the upright position.

16. The food rack of claim 12, wherein:
each holding member of the plurality of holding members further comprises a second prong extending upwardly from the main body and configured to pierce and retain food thereon; and
the second prong is spaced apart from the first prong such that the food retained by the first and second prongs are separated from one another by a predetermined distance for evenly cooking the food.

17. A food rack, comprising:
a frame configured to contact a cooking surface of a cooker, the frame comprising:
a first beam extending along a longitudinal axis, said first beam having a first end and a second end opposite the first end;
a second beam perpendicular to the longitudinal axis and connected to the first end of the first beam; and
a third beam perpendicular to the longitudinal axis and connected to the second end of the first beam;
a handle connected to the first beam and extending upwardly therefrom when the food rack is in an upright position and supported by the cooking surface, wherein the cooking surface extends generally horizontally; and
a plurality of holding members comprising first, second, and third sets of holding members respectively connected to and evenly spaced along the first, second, and third beams,
wherein:
each holding member of the plurality of holding members extends upwardly from the frame and away from the cooking surface when the food rack is in an upright position;
each holding member of the plurality of holding members comprises a main body and a first prong extending upwardly from the main body when the food rack is in the upright position; and
the first prong of each holding member of the plurality of holding members is configured to pierce and hold food thereon.

18. The food rack of claim 17, wherein:
the second and third sets of holding members are perpendicularly offset from the first set of holding members to evenly space apart and cook the food.

19. The food rack of claim 17, wherein the frame further comprises lateral support beams connected to and extending inwardly from the second and third beams such that the lateral support beams extend toward each other.

20. The food rack of claim 17, wherein:
the second and third sets of holding members are equal in number;
the first set of holding members is greater in number than each of the second and third sets of holding members; and
a spacing is the same between holding members of the first set of holding members, the second set of holding members, and the third set of holding members.
